(19) United States
(12) Patent Application Publication
(10) Pub. No.: US 2014/0183131 A1
(43) Pub. Date: Jul. 3, 2014

(54) METHOD AND SYSTEM FOR REMOVAL OF DISSOLVED ORGANIC COMPOUNDS IN PROCESS WATER

(71) Applicant: Dennis Søgaard, Struer (DK)

(72) Inventor: Dennis Søgaard, Struer (DK)

(73) Assignee: PURETEQ A/S, Svendborg (DK)

(21) Appl. No.: 14/233,500

(22) PCT Filed: Jul. 20, 2012
(86) PCT No.: PCT/EP2012/064293

§ 371 Date: Jan. 17, 2014

(30) Foreign Application Priority Data
Jul. 21, 2011 (EP) 11174838.0

(51) Int. Cl. C02F 9/00; C02F 1/06; C02F 1/16; C02F 1/26

(52) U.S. Cl. CPC C02F 9/00; C02F 1/26; C02F 1/06; C02F 1/16
USPC 210/634; 202/169

(57) ABSTRACT

The present invention relates to a method for removal of dissolved organic compounds, in particular bioaccumulative substances, in process water (eg. of the petrochemial industry) and to a system for carrying out the inventive method. Process water containing toxic and/or bioaccumulative substances is mixed in the mixing vessel (2) with an extractant. The resulting emulsion is directed into a separation vessel (3) to separate the aqueous phase from the organic phase. The aqueous phase is directed into a first distillation unit (5), where vaporisation of the extractant is carried out. The organic phase is directed to a second distillation unit (7). The resulting distillate is recirculated via a condenser unit (8) into the mixing vessel (2).

### FIELD OF INVENTION

The present invention relates to a method for removal of dissolved organic compounds, in particular bioaccumulative substances, in process water and to a system for carrying out the inventive method.

### BACKGROUND

The oil industry produces around 2.5 times more water than oil. Typically, such process water contains high concentrations of bioaccumulative and/or toxic substances. Dissolved organic compounds occurring naturally in process water from the petrochemical industry include organic acids, polycyclic aromatic hydrocarbons (PAHs), phenols, aliphatic hydrocarbons and volatiles. These hydrocarbons are likely contributors to process water toxicity and its bioaccumulative potential. In particular, PAHs increase biological oxygen demand and potentially carcinogenic and mutagenic. Dissolved aromatic hydrocarbons and phenols have been found to contribute considerably to the toxicity of process water from the oil industry.

Current methods for treating such process water may remove a great deal of TOC (total organic carbon); but in particular bioaccumulative substances are not removed to a satisfactory degree. This results in a post-treatment of water with high nitrification inhibition potential and high content of bioaccumulative substances.

The purification method of the present invention overcomes these drawbacks in that it targets these compounds particularly.

Thus, it is an object of the present invention to provide a method for purification of process water, e.g. from the oil industry, that is more efficient than the prior art methods in removing bioaccumulative and/or toxic substances.

It is a second object of the present invention to provide a method for purification of process water, e.g. from the oil industry, that is more efficient than the prior art methods for removing lipophilic substances.

It is a further object of the invention to provide a method for purification of process water reducing the need for organic chemicals and/or reusing the chemicals needed for the purification.

It is a further object of the invention to provide a method for purification of process water minimising the discharge of polluting material.

It is a further object of the invention to provide a method for purification of process water being cost-efficient and relatively simple.

In the experimental process leading to the present invention, the inventor found that organic extractants can be very efficient in withdrawing dissolved organic contaminants from process water. It was found that when the organic extractant was recycled in the process, it became an increasingly favourable organic extractant with broader solubility properties.

### SUMMARY OF THE INVENTION

The new and unique way in which one or more of the above objects are addressed is a method for removal of dissolved organic compounds in process water comprising
a first step of mixing the process water with an organic extractant to form an emulsion, said emulsion comprising an aqueous phase and an organic phase,
a second step of separating the aqueous phase from the organic phase,
a third step of subjecting the aqueous phase emanating from the second step to heat and/or subatmospheric pressure for vaporising dissolved organic extractant from the aqueous phase,
a fourth step of subjecting the organic phase emanating from the second step to distillation to form (i) a distillate comprising the organic extractant and (ii) a residue comprising the organic compounds,
a fifth step of condensing the distillate (i) emanating from the fourth step and recycling the distillate into the first step as organic extractant.

In another aspect, the present invention relates to a system for carrying out the method of the present invention, the system comprising
a mixing vessel,
a separation vessel in fluid communication with the mixing vessel,
a first and a second distillation unit, each unit being in fluid communication with the separation vessel,
a condenser unit in fluid communication with the mixing vessel and with the second distillation unit.

### DEFINITIONS

As used herein, the term “bioaccumulative substance” refers to an organic substance with a log octanol water partitioning coefficient (log P_{ow}) of at least 3, such as e.g. at least 4, such as e.g. at least 5. However, any organic compounds having log P_{ow} of at least about 1, such as e.g. at least about 1.5, such as e.g. at least about 2, such as e.g. at least about 2.5, may also be a subject of the invention. Bioaccumulation occurs when an organism absorbs a substance at a rate greater than that at which the substance is lost. Thus, the longer the biological half-life of the substance, the greater the risk of accumulation of the substance in the organism, and if the substance is toxic; the greater the risk of chronic poisoning, even if environmental levels of the toxin are not very high.

As used herein, the term “process water” refers to an aqueous process fluid of an industrial process, in particular a petrochemical process, such as oil recovery from bituminous deposits such as oil sands or oil shale, such as produced water. Process water may also result from washing of oil tanks, bilge water or water used or resulting from de-salting of crude oil.

The term “subatmospheric pressure” is to be understood as an absolute pressure of less than 101.325 kPa which is also known to be 1 atm which in turn is 1.01325 bar.

As used herein, the term “distillation” involves application of heat and/or subatmospheric pressure to a liquid mixture leading to vaporisation of part of the mixture. The resultant condensed distillate is richer in the more volatile components, whereas the residue is richer in the less volatile components.

### DISCLOSURE OF THE INVENTION

In a first aspect, the present invention relates to a method for removal of dissolved organic compounds in process water comprising;
a first step of mixing the process water with an organic extractant to form an emulsion, said emulsion comprising an aqueous phase and an organic phase,
a second step of separating the aqueous phase from the organic phase,
a third step of subjecting the aqueous phase emanating from the second step to heat and/or subatmospheric pressure for vaporising dissolved organic extractant from the aqueous phase,
a fourth step of subjecting the organic phase emanating from the second step to distillation to form (i) a distillate comprising the organic extractant and (ii) a residue comprising the organic compounds,
a fifth step of condensing the distillate (i) emanating from the fourth step and recycling the distillate into the first step as organic extractant.

The inventive method has surprisingly shown to be very efficient for removing bioaccumulative substances from the process water from e.g. the petrochemical industry. Moreover, the process has also been found to be very efficient in removing compounds considered toxic in the sense that they inhibit the nitrification seen in microbiological processes used in purifying waste water.

Preferably, the first step is carried out by mixing the process water with the extractant by stirring in a stirring vessel. Thereby, the extractant becomes dispersed in droplets within the process water, i.e. an emulsion is formed. Thus, organic compounds, such as bioaccumulative substances, being dissolved in the process water are transferred predominantly into the organic phase, i.e. the organic extractant. Then, the emulsion is transferred preferably to a separation vessel for phase separation in the second step. Typically, the mixing tank has a volume of about 1000 L and is stirred mechanically usually using well-known means for agitation such as e.g. a propeller blade usually at e.g. about 2800 rpm. This tank can be fed continuously with process water and extractant by two separate inlets such that the volume in the stirring tank is held approximately constant. From the stirring tank, there may be an outlet with means for transporting the liquid from the stirring tank into a tank for phase separation allowing for separation of the water phase and the extractant. Usually, the extractant has a lower density than water and will consequently form a layer on top of the aqueous layer.

After phase separation, the aqueous phase is separated and advantageously transferred to a distillation unit, optionally via an additional container serving as volume buffer. In the third step, a distillation can be carried out in that the aqueous phase, which still contains a minor amount of dissolved organic extractant, is heated to a temperature exceeding the boiling point of the water-extractant azeotrope. If, for example, toluene is the extractant, the aqueous phase will still contain around 470 mg/L of toluene (equals solubility of toluene in water). Pure toluene has a boiling point of 110.6° C. (at normal pressure; 1 atm), whereas water has a boiling point of 100° C. (normal pressure, 1 atm.). The azeotrope of water and toluene has a boiling point of 84.1° C. (normal pressure, 1 atm.). Thus, in the distillation unit, a toluene-water azeotrope can be distilled off at about 87° C. The resulting gas phase contains around 80% toluene and 20% water. When all toluene has been removed from the liquid phase, the temperature may be raised to 100° C. for e.g. two minutes or more to ensure complete removal of toluene from the aqueous phase.

Alternatively, the aqueous phase emanating from the second step may undergo heat exchange with one or more condensers from the fifth step to heat it up only slightly, e.g. heated up by about 10° C. to about 50° C., such as e.g. about 20° C. to about 40° C. such as e.g. about 20° C. to about 30° C. That aqueous phase may then be transferred into one or more distillation units allowing the pressure to be adjusted to subatmosheric pressures, e.g. about 0.5 bar, for effecting a vaporisation of extractant and/or water-extractant azeotrope. The vaporisation process can be further enhanced by increasing the surface area of the fluid-gas interface, e.g. by recirculating the aqueous phase within the distillation unit through a sprinkling system with one or more nozzles for continuously spraying small droplets of aqueous phase from the upper part of the unit. The advantage of such embodiments is that the required energy input is reduced as compared to embodiments, where the entire aqueous phase has to be heated to the boiling point of a water-extractant azeotrope. Thus, in a preferred embodiment, the third step is carried out at a subatmospheric pressure, such as an absolute pressure of below 0.9 bar, such as e.g. e.g. below about 0.8 bar, such as e.g. below about 0.7 bar, such as e.g. below about 0.6 bar or such as e.g. below about 0.5 bar, such as e.g. below about 0.4 bar, such as e.g. below about 0.3 bar, such as e.g. below about 0.2 bar, such as e.g. below about 0.1 bar. Alternatively, the subatmospheric pressure may be in a range from e.g. about 0.9 bar to about 0.1 bar, such as e.g. 0.8 bar to about 0.1 bar, such as e.g. about 0.7 bar to about 0.1 bar, such as e.g. about 0.6 bar to about 0.1 bar, such as e.g. about 0.5 bar to about 0.1 bar, such as e.g. about 0.4 bar to about 0.1 bar, such as e.g. about 0.3 bar to about 0.1 bar, such as e.g. about 0.2 bar to about 0.1 bar.

Thus, in a preferred embodiment, at least part of the heat energy of the distillate emanating from the fourth step is used to heat the aqueous phase in the third step.

After this treatment, the remaining liquid aqueous phase can be discharged into the environment due to the efficient removal of bioaccumulative substances. The resulting aqueous phase may optionally pass an active coal filter prior to discharge into the environment or use for another purpose.

In the fourth step, the organic phase from the second step may be directed into a distillation unit, where it is, for example, heated to about 120° C. if toluene is used as extractant. At this temperature toluene is distilled off. Thus, the temperature during the distillation is dictated by the boiling point of the extractant used in the process such that the temperature is about 5° C. to about 30° C. higher or lower than the boiling point of the pure extractant and may also be in a temperature interval stretching from e.g. about 5° C. to about 30° C. higher than the boiling point of the extractant to e.g. about 5° C. to about 30° C. lower than the boiling point of the extractant, such as e.g. about 10° C. to about 20° C. or about 15° C. higher or lower than the boiling point of the extractant. The bioaccumulative lipophilic substances remain predominantly in the liquid phase in this distillation step. For example, if toluene is used as extractant, the distilled toluene usually still contains some organic substances that boil below 120° C. The residue in the process (i.e. compounds boiling at higher temperatures) is collected for further use in other processes.

The distillate of the fourth step consists predominantly of the original extractant (e.g. toluene), but also contains organic compounds that boil below the temperature of distillation in the fourth step. Preferably, the distillate emanating from the fourth step is a distillate obtained in a temperature interval around the boiling point of the extractant. Such interval may be +/−30° C. such as +/−20° C., such as e.g. about +/−10° C., such as e.g. +/−5° C. from the boiling temperature of the extractant. If e.g. toluene is used as extractant, the temperature interval may be between 70 and 140° C. Accordingly, all organic substances having a boiling point, which falls in this interval, will be transferred to the distillate and ultimately recycled into the process.

Since the distillate of the fourth step contains said organic substances stemming from the initial process water, it becomes an increasingly favourable organic extractant (broader extraction properties) once it has been recycled back to the first step. Consequently, according to the present method, the composition of extractant used in the first step is changing continuously due to the recycling step. Initially, the extractant may be, for example, pure toluene. However, as this extractant is recycled, it will usually comprise toluene as a major constituent and other organic compounds typically with a similar boiling point as minor constituents. Thus, the extractant will gradually become a mixture of organic compounds, which will form a tailor-made extractant with superior extraction properties and thus will become an especially designed extractant for its purpose and may thus be batch-specific depending on the composition of organic compounds present in the process water. If, for example, the distillate in the fourth step is obtained between 70 and 140° C. it will contain organic compounds with a boiling point falling within this interval. It has been surprisingly found that this continuously changing composition of the extractant contributes significantly to removing toxic and/or bioaccumulative substances from the process water. Another major advantage of the recycling of the organic extractant is the great reduction in use of the amount of organic chemicals in the method of the present invention. This reduces environmental impact and lowers costs. Thus, the method according to the invention provides for a gradient extraction in the sense that the extractant initially comprises 100% of the starting solvent (such as e.g. toluene) and gradually changes its contents with each cycle with increasing incremental amount of other organic substances present in the produced/process water.

Consequently, the method according to the invention can be repeated as many times as desirable to afford process water having the prescribed compositions as far as environmental requirements concern. For example, the method may be repeated at least 1 time or more, such as e.g. at least 2 times or more, such as e.g. 3 times of more, such as e.g. 4 times or more, such as e.g. 5 times or more, such as e.g. 6 times or more, such as e.g. 7 times or more, such as e.g. 8 times or more, such as e.g. 9 times or more, such as e.g. 10 times or more, such as e.g. 100 times or more. Moreover, the process may be operated continuously for e.g. several days, such as e.g. about 1 week or more, such as e.g. 3 weeks or more, such as e.g. 1 month or more, such as e.g. 3 months or more, such as e.g. 6 months or more, such as e.g. 1 year or more.

According to another embodiment, the method comprises a sixth step of contacting the residue of the fourth step with water for forming an emulsion. This has been found to lower the viscosity of the residue making it easier to withdraw the residue as an emulsion by pumping. Preferably, water vapour is used to this end. The water vapour may be injected into the same distillation unit in which the fourth step is carried out. Also, residual extractant can be removed from the residue in this way. If, for example, toluene is used as extractant, the sixth step may be carried out at about 87° C. to distil off a toluene-water azeotrope. Typically, the residue of the sixth step will contain a major part of the toxic and bioaccumulative substances present in the original process water. This residue if transferred into a so-called slop tank. This residue may be combusted to produce energy.

According to another embodiment, the distillate emanating from the sixth step is recycled into the first step. In this way, an even larger fraction of the overall extractant is recovered and recycled with the inventive method making it more efficient and less costly.

Likewise, the vaporised organic extractant emanating from the third step can be recycled into the first step.

According to another embodiment, the organic extractant comprises benzene, toluene, ethylbenzene and/or xylenes (ortho-, meta- and para-xylene or any mixtures thereof) or any combinations thereof. Moreover, other organic compounds such as e.g. cyclohexane, various alcohols such as e.g. ethanol, propanol (including any isomers thereof), butanol (including any isomers thereof), cyclohexanol and ethyl acetate may also be used as extractants or any combinations thereof. One important feature of the invention is that the extractant may act as an azeotrope component with water such that the extractant and water in combination form an azeotrope. A person skilled in the art will know the exact boiling point of each of the above-mentioned solvents in an azeotrope mixture with water. Preferably, the extract and water should form an azeotrope having a boiling point of about 85° C. to about 100° C. at normal pressure (1 atm.). Such extractants may be e.g. n-propanol, n-butanol, sec-butanol, iso-butanol, allyl alcohol, benzyl alcohol, furfuryl alcohol, cyclohexanol, pyridine, toluene, anisole or chloral or any mixtures thereof.

According to a particularly preferred embodiment, the organic extractant comprises toluene. Preferably, the initial organic extractant consists of toluene of at least commercial grade (at least 90 wt % toluene). Toluene has surprisingly been found to be particularly efficient in removing toxic and/or bioaccumulative organic substances from process water.

According to another embodiment, the volume ratio of organic extractant to process water is between about 1:100 to about 1:1, such as e.g. about 1:50 to about 1:2, such as e.g. about 1:40 to about 1:5, preferably between about 1:20 to about 1:10 or e.g. about 1:5, such as e.g. about 1:10, such as e.g. about 1:20, such as e.g. about 1:50. Preferably, an amount of 50-100 L toluene is mixed with each 1000 L of process water. This ratio was found to yield particularly good results in terms of extraction efficiency and overall process economy.

According to one embodiment, the first step is carried out by stirring the organic extractant and the process water in a mixing vessel.

According to another embodiment, the second step is carried out by gravity separation in a separation vessel. Thus, the emulsion created in the first step is separated typically by organic phase droplets, i.e. extractant plus bioaccumulative substances, moving upwards through the aqueous phase to form an organic phase on top of the aqueous phase. This has been found to be a simple and efficient setup to achieve phase separation and a good extraction of organic compounds from the process water.

Advantageously, in the third step, the aqueous phase is heated to a temperature above the boiling point of the water-extractant azeotrope and below the boiling point of water. All fractions having a boiling temperature below the azeotrope are also collected and transferred to a slop tank and are thus not further included in the extraction process. Moreover, any fractions with higher boiling point than about 100° C. will also be separated from the water-extractant azeotrope and consequently, the result is an water-extractant azeotrope heaving fractions with a boiling point in the range of about 85° C. to about 100° C. This results in an efficient distillation of the water-extract azeotrope and thus a purification of the remaining aqueous phase from the extractant.

According to a preferred embodiment, the organic extractant is toluene and the aqueous phase is heated to a temperature between 84.2° C. and 88° C. in the third step to distil off the toluene-water azeotrope. The toluene should be at least of commercial grade (at least 90 wt % toluene).

According to another embodiment, in the third step, following a distillation of a water-extractant azeotrope, the temperature is raised to at least 100° C., such as e.g. at least about 110° C., such as e.g. at least about 120° C. or such as e.g. at least about 130° C. Preferably, the temperature is raised to this temperature only for a maximum of a few minutes. This will ensure that all organic extractant is removed from the residue provided that the extractant has a boiling point below 100° C.

According to another embodiment, the method is continuous in that a continuous flow of process water is treated by said steps and a continuous recycling of distillate from the fifth step into the first step is established. By carrying out the method in a continuous mode, a particularly high efficiency can be obtained.

Advantageously, the distillation temperature in the fourth step is between the boiling point of the organic extractant and a temperature that is at least 10° C. above the boiling point of the organic extractant, such as e.g. about 20° C. above, such as e.g. about 30° C. above, such as e.g. about 40° C., such as e.g. about 50° C. above the boiling point of the organic extractant.

According to another embodiment, the process water originates from the exploitation of bituminous sands, oil shale and or shale gas. The process of the present invention is particularly suited for these industrial processes since toxic and/or bioaccumulative substances dissolved in process water of such processes can be particularly well extracted with this method.

According to another embodiment, the method is carried out onshore. This includes treating process water with the inventive method in the context of onshore oil and gas exploration, drilling, production operations and/or refining operations.

According to another embodiment, the method is carried out offshore. As used herein, the term “offshore” refers to the method being carried out at sea as opposed to on land.

According to another embodiment, the organic compounds comprise one or more bioaccumulative substance with a log octanol water partitioning coefficient (log P_{ow}) of at least about 1 or more, such as e.g. about 2 or more, such as e.g. 3 or more or such as e.g. at least about 3.5 or more, such as e.g. about 4.0 or more, such as e.g. about 5.0 or more.

In another aspect, the present invention relates to a system for carrying out the method of the present invention, the system comprising
a mixing vessel,
a separation vessel in fluid communication with the mixing vessel,
a first and a second distillation unit, each unit being in fluid communication with the separation vessel,
a condenser unit in fluid communication with the mixing vessel and with the second distillation unit.

According to a preferred embodiment, the system provides for pressure equalisation between all vessels.

According to yet another aspect, the present invention relates to a method for removal of dissolved organic compounds in process water comprising
a first step of mixing the process water with an organic extractant to form an emulsion, said emulsion comprising an aqueous phase and an organic phase,
a second step of separating the aqueous phase from the organic phase,
a third step of treating the aqueous phase emanating from the second step in a wet scrubber for removing dissolved organic extractant from the aqueous phase,
a fourth step of subjecting the organic phase emanating from the second step to distillation to form (i) a distillate comprising the organic extractant and (ii) a distillation residue comprising the organic compounds,
a fifth step of condensing the distillate emanating from the fourth step and recycling the distillate into the first step as organic extractant.

Moreover, the present invention relates to a method for removal of dissolved organic compounds in process water comprising
a first step of mixing the process water with an organic extractant to form an emulsion, said emulsion comprising an aqueous phase and an organic phase, wherein the extractant and water form an azeotrope,
a second step of separating the aqueous phase from the organic phase,
a third step of treating the aqueous phase emanating from the second step in a wet scrubber for removing dissolved organic extractant from the aqueous phase or treating the aqueous phase emanating from the second step in a wet scrubber for removing dissolved organic extractant from the aqueous phase,
a fourth step of subjecting the organic phase emanating from the second step to distillation to form (i) a distillate comprising the organic extractant and (ii) a distillation residue comprising the organic compounds,
a fifth step of condensing the distillate emanating from the fourth step and recycling the distillate into the first step as organic extractant, thereby gradually enriching the extractant with organic compounds present in the process water.

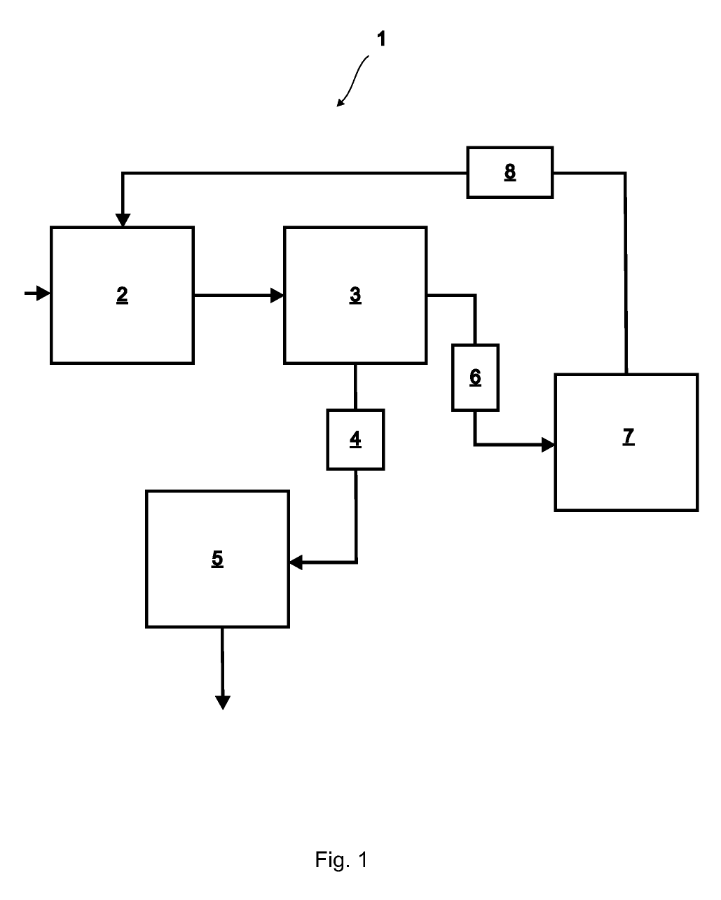

FIG. 1 shows a schematic flow chart of one embodiment of the method and system of the present invention. The system 1 in FIG. 1 comprises a mixing vessel 2 with inlets for process water containing toxic and/or bioaccumulative substances and extractant (not shown). In the mixing vessel, the organic extractant, for example toluene, and the process water are mixed, for example by stirring. The resulting emulsion is directed into a separation vessel 3, preferably by an ordinary overflow. In the separation vessel 3, which may be a gravity separation vessel, the small organic droplets of the emulsion move upwards to form an organic phase on top of the aqueous phase. The movement of the drops may be described as leading to a counter-current extraction in that the organic droplets move upwards through the aqueous phase that moves downward. The toxic and/or bioaccumulative substances will now be predominantly dissolved in the organic phase.

After phase separation, the aqueous phase is withdrawn, optionally into a container 4 serving as volume buffer. From there, the aqueous phase is directed into a first distillation unit 5 where vaporisation of the extractant is carried out. The distillate can be withdrawn from distillation unit 5 and may be recirculated to mixing vessel 2 and/or to separation vessel 3 (not shown). Similarly, the organic phase is withdrawn from separation vessel 3, after phase separation, and is directed into a second distillation unit 7 via a volume buffer container 6. In distillation unit 7, the organic phase is heated to a temperature higher than the boiling point of the organic extractant. The resulting distillate is recirculated via a condenser unit 8 into mixing vessel 2 and/or into separation vessel 3. The residue, which comprises a major part of the toxic and/or bioaccumulative substances, can be combusted to produce energy.

### EXAMPLE

In a test example, water from an oil production platform was analysed with respect to its contents of benzene and hydrocarbons having from 10 carbon atoms (C10) and hydrocarbons up to 35 carbon atoms (C35). According to the analysis, the following constituents were found to be present in the water sample before any purification had been undertaken:

| | |
|---|---|
| Benzene-C10 | 1300 μg/L |
| C10-C25 | 91000 μg/L |
| C25-C35 | 49000 μg/L |
| Sum (Benzene-C35) | 140000 μg/L |

The analysis of the samples for determination of total hydrocarbon content was performed by GC according to well-known standard method 19377-2m GC/FID. The octanol-water partition coefficient was determined by the MK4261 DS/EN1484 standard. Moreover, the nitrification inhibition was found to be 71% which is considered toxic for microorganisms and would potentially destroy any system using microbiological processes for cleaning water. Additionally, the Log P_{ow} was found to be in a range of 1.4-2.3 having 6 organic components in this range.

The nitrification inhibition was tested according to DS/EN ISO 9509 (1996) at a temperature of 20° C.±2° C. for 4 hours using a volume of 250 ml and pH of 8.1. The sample was diluted 5 times (200 ml/L) and the test was replicated 3 times.

Typically, 1000 L of process water is placed in a stirring tank equipped with a mechanical stirrer with a 4 kW capacity affording a stirring rate of ca. 2800-3000 rpm of the stirring propeller. To this was added 100 L of toluene and the resulting mix was stirred such that an emulsion is formed between toluene and water. About 500-300 L is transferred to another tank to allow for separation of the organic extractant phase from the aqueous phase. The aqueous phase was then distilled starting the heating at ambient temperature to gradually heat the aqueous phase up to about 85° C. All fraction collected below this temperature is collected in a slop tank. The distillate between 85° C. and 100° C. is collected and recycled back to the mixing tank. The remaining mixture, being predominantly water, is then heated to about 105° C. to distil pure water which is collected and analysed with respect to its contents of benzene-C35 and its contents of nitrification inhibiting properties. Then, the temperature is raised further to collect high boiling fractions which are transferred to the slop tank.

In the purified water the following constituents were found:

| | | |
|---|---|---|
| Benzene-C10 | 19 | μg/L |
| C10-C25 | 400 | μg/L |
| C25-C35 | 140 | μg/L |
| Sum (Benzene-C35) | 560 | μg/L |

Moreover, the nitrification inhibition was found to be below detection (i.e. about 0%), and the presence of any bioaccumulative compounds could not be detected, such that no compounds were found to have any Log P_{ow} in range of 1 to about 5.

Consequently, the method according to present invention is very efficient in removing unwanted bio hazardous material in a cost efficient manner.

1. A continuous method for removal of dissolved organic compounds in process water comprising the steps of;
mixing the process water with an organic extractant to form an emulsion, said emulsion comprising an aqueous phase and an organic phase;
separating the aqueous phase from the organic phase;
separating the organic extractant from the aqueous phase by (i) subjecting the aqueous phase to at least one of heat or subatmospheric pressure for vaporising the dissolved organic extractant from the aqueous phase, wherein the vaporised organic extractant is recycled to repeat the mixing step, or (ii) treating the aqueous phase in a wet scrubber for removing the dissolved organic extractant from the aqueous phase;
subjecting the organic phase to distillation to form (i) a distillate comprising the organic extractant and (ii) a residue comprising the organic compounds; and
condensing the distillate, and recycling the distillate as organic extractant for repeating the mixing step.

2. The method according to claim 1, wherein the organic extractant forms an azeotrope with water.

3. The method according to claim 1, wherein the organic extractant forms a water-extractant azeotrope, and wherein the water-extractant azeotrope has a boiling point in the range of about 85° C. to about 100° C.

4. The method according to claim 1, wherein the separating the organic extractant from the aqueous phase comprises subjecting the aqueous phase to at least one of heat or subatmospheric pressure for vaporising, and wherein the subjecting the aqueous phase to at least one of heat or subatmospheric pressure for vaporizing is an azeotrope distillation.

5. The method according to claim 4, wherein the azeotropic distillation is performed at a temperature in a range of near or at the boiling point of the azeotrope to above the boiling point of the azeotrope.

6. The method according to claim 4, wherein the azeotropic distillation is performed in a temperature range from near or at the boiling point of the azeotrope to at least 10° C. above the boiling point of the azeotrope.

7. The method according to claim 4, wherein the temperature of a water-extractant azeotrope, following the azeotropic distillation, is raised in the third step to at least 100° C.

8. The method according to claim 7, wherein the raised temperature is maintained for about 10 minutes.

9. The method according to claim 1, wherein the subjecting the organic phase to distillation is performed in a temperature range between the boiling point of the water-extractant azeotrope and the boiling point of the organic extractant.

10. The method according to claim 1, further comprising contacting the residue with water for forming an emulsion.

11. (canceled)

12. The method according to claim 1, wherein the organic extractant comprises benzene, toluene, ethylbenzene and/or xylenes, n-propanol, n-butanol, sec-butanol, iso-butanol, allyl alcohol, benzyl alcohol, furfuryl alcohol, cyclohexanol, pyridine, toluene, anisole or chloral or any mixtures thereof.

13. The method according to claim 1, wherein the organic extractant comprises toluene.

14. The method according to claim 1, wherein the volume ratio of organic extractant to process water is between about 1:100 to about 1:1.

15. The method according to claim 1, wherein separating the aqueous phase from the organic phase is carried out by gravity separation in a separation vessel.

16. The method according to claim 1, wherein the subjecting the organic phase to distillation creates heat energy, and wherein the heat energy is used to heat the aqueous phase for separating the dissolved organic extractant from the aqueous phase.

17. The method according to claim 1, wherein the method is continuous in that a continuous flow of process water is treated by said steps and a continuous recycling of distillate from the step of condensing the distillate into the step of mixing the process water is established.

18. The method according to claim 1, wherein the process water originates from an exploitation of bituminous sands, oil shale, washings of oil tanks, bilge water or water used or resulting from de-salting of crude oil or shale gas or any combinations thereof.

19. The method according to claim 1, wherein the separating the dissolved organic extractant from the aqueous phase is carried out at a subatmospheric pressure.

20. The method according to claim 1, wherein the method is repeated at least 1 time.

21. The method according to claim 1, wherein the method is continuously operated for several days.

22. The method according to claim 1, wherein the method is carried out offshore.

23. The method according to claim 1, wherein the dissolved organic compounds to be removed from the process water comprise one or more bioaccumulative substances with a log octanol water partitioning coefficient (log P_{ow}) of at least 1.

24. A system for carrying out the method as claimed in claim 1, comprising
a mixing vessel,
a separation vessel in fluid communication with the mixing vessel,
a first distillation unit and a second distillation unit, each distillation unit being in fluid communication with the separation vessel, and
a condenser unit in fluid communication with the mixing vessel and with the second distillation unit.

25. The system according to claim 24, wherein the system provides for pressure equalisation between all vessels.

26. The system according to claim 24, further comprising one or more buffer tanks.

27. The method according to claim 4, wherein the azeotropic distillation is performed in a temperature range from near or at the boiling point of the azeotrope to at least 20° C. above the boiling point of the azeotrope.

28. The method according to claim 4, wherein the azeotropic distillation is performed in a temperature range from near or at the boiling point of the azeotrope to at least 50° C. above the boiling point of the azeotrope.

29. The method according to claim 4, wherein the temperature of the water-extractant azeotrope, following the azeotropic distillation, is raised to at least 110° C.

30. The method according to claim 4, wherein the temperature of the water-extractant azeotrope, following the azeotropic distillation, is raised to at least 130° C.

31. The method according to claim 4, wherein the raised temperature is maintained for about 5 minutes.

32. The method according to step 1, wherein the volume ratio of organic extractant to process water is between about 1:50 to about 1:2.

33. The method according to step 1, wherein the volume ratio of organic extractant to process water is between about 1:5 to about 1:2.

34. The method according to step 1, wherein the volume ratio of organic extractant to process water is between about 1:40 to about 1:5.

35. The method according to step 1, wherein the volume ratio of organic extractant to process water is between about 1:20 to about 1:10.

36. The method according to claim 1, wherein the method is repeated at least 10 times more.

37. The method according to claim 1, wherein the method is repeated at least 100 times more.

38. The method according to claim 1, wherein the method is continuously operated for 1 week or more.

39. The method according to claim 1, wherein the method is continuously operated for 1 month or more.

40. The method according to claim 1, wherein the method is continuously operated for 1 year or more.

41. The method according to claim 1, wherein the method is continuously operated for 6 months or more.
